(19) United States
(12) Patent Application Publication
(10) Pub. No.: US 2011/0210147 A1
(43) Pub. Date: Sep. 1, 2011

(54) Dual Head Injector with Single Motor and Back-Drive Lock

(76) Inventor: Frank M. Fago, Mason, OH (US)

(21) Appl. No.: 12/673,772

(22) PCT Filed: Aug. 15, 2008
(86) PCT No.: PCT/US2008/073222

§ 371 Date: Feb. 17, 2010

Related U.S. Application Data
(60) Provisional application No. 60/956,944, filed on Aug. 21, 2007.

(51) Int. Cl. B67D 7/60

(52) U.S. Cl. 222/386

(57) ABSTRACT

A drive train (102) for a dual-head power injector is disclosed that utilizes a single motor (106). The motor (106) may be moved to couple with a first syringe driver (138a). In one embodiment, this same movement also simultaneously locks a second syringe driver (138b). In any case, this motor (106) may also be moved to couple with the second syringe driver (138b). In one embodiment, this same movement also simultaneously locks the first syringe driver (138a).

### RELATED APPLICATIONS

This application claims priority to U.S. provisional application Ser. No. 60/956,944 filed on 21 Aug. 2007 entitled DUAL-HEAD INJECTOR WITH SINGLE MOTOR AND BACK-DRIVE LOCK.

### BACKGROUND

Power injectors are commercially available to discharge one or more desired medical fluids. Typical components of a power injector include a console (e.g., an interface for programming the power injector for a procedure), a drive source (e.g., a motor), a powerhead, a display or user interface screen that may be associated with the powerhead, and one or more syringes. Each syringe may be detachably coupled with the powerhead. A pressure jacket may be incorporated into the powerhead to house a syringe for high-pressure injections.

An operative coupling may also be provided between the powerhead and each syringe. For instance, the powerhead may incorporate a ram that is axially moved by a drive source in a desired manner. Each ram may detachably interface with a plunger of the associated syringe such that its axial motion is transmitted to the plunger to discharge fluid from the associated syringe, and to draw fluid into the associated syringe or to at least accommodate loading fluid into the associated syringe.

In some instances it may be desirable to be able to inject more than one type of fluid (e.g., saline and contrast media). Dual-head power injectors may utilize a pair of the above-noted rams and each of which may interface with the plunger of its corresponding syringe to advance the plunger at least for an injection (e.g., the ram may detachably interface with the plunger, and may also retract the plunger when coupled therewith). At least one known dual-head power injector uses a single, stationary power source and a transmission for switching power between its two syringes. However, in many cases dual-head power injectors actually use two separate, stationary drive sources. This obviously increases costs. The drive source for an MRI power injector is a particularly expensive unit due to the required adaptations for this particular application. Therefore, having these two separate drive sources adds substantially to the cost of the power injector.

### SUMMARY

A first aspect of the present invention is generally directed to an injector. This injector includes first and second syringe drivers, as well as a first drive source. The first drive source is movable to a first position to selectively couple with the first syringe driver, and furthermore is movable to a second position to selectively couple with the second syringe driver. The injector of the first aspect also includes at least one syringe driver lock. Each of the first and second syringe drivers may be selectively locked by a syringe driver lock.

Various refinements may exist of features noted above in relation to the first aspect of the present invention. Further features may also be incorporated in the first aspect of the present invention as well. These refinements and additional features may exist individually or in any combination. The entirety of the following discussion, up to the start of the discussion of the second aspect, pertains to this first aspect.

The injector may include a drive gear, a first driven gear, and a second driven gear. The drive gear may be driven by the first drive source, the first driven gear may be at least operatively coupled with the first syringe driver (including a direct coupling), the second driven gear may be at least operatively coupled with the second syringe driver (including a direct coupling), and the drive gear may be selectively coupled with each of the first and second driven gears through a certain movement of the first drive source. One movement of the first drive source may provide for a coupling between the drive gear and the first driven gear, such that a rotation of the drive gear is transmitted to the first driven gear and to thereby move at least part of the first syringe driver. Another movement of the first drive source may provide for a coupling between the drive gear and the second driven gear, such that a rotation of the drive gear is transmitted to the second driven gear and to thereby move at least part of the second syringe driver.

The injector may include a carriage, where the first drive source and the above-noted drive gear are each associated and move along with the carriage (e.g., by being mounted on or interconnected with the carriage in any appropriate manner). The carriage may be of any appropriate size, shape, configuration, and/or type, for instance in the form of a pivot bracket or the like. In one embodiment, at least part of the carriage is disposed between the first driven gear (associated with the first syringe driver) and the second driven gear (associated with the second syringe driver). This carriage may be associated with one or more syringe driver locks associated with the first and second syringe drivers. For instance, first and second syringe driver locks may be associated and move along with the carriage, where the first syringe driver lock may be selectively coupled with the first driven gear through a first movement of the carriage, where the second syringe driver lock may be selectively coupled with the second driven gear through a second movement of the carriage, and where these first and second movements differ in at least some respect.

Any appropriate motion or combination of motions may be utilized by the above-noted carriage, including a pivotal motion (e.g., where the carriage is mounted on a pivot). In one embodiment, a pivotal motion of the carriage in a first direction causes the drive gear to be coupled with the first driven gear (associated with the first syringe driver) and furthermore causes the second syringe driver lock to be coupled with the second driven gear (associated with the second syringe driver). A pivotal motion of the carriage in a second direction may cause the above-noted drive gear to be coupled with the second driven gear (associated with the second syringe driver) and furthermore may cause the first syringe driver lock to be coupled with the first driven gear (associated with the first syringe driver). The first and second directions of these pivotal motions of the carriage may be opposite of each other.

The first and second syringe driver locks may be integrally formed with the carriage such that there is no joint of any kind between the carriage and each of the first and second syringe driver locks. That is, the first and second syringe driver locks may be part of or formed into the structure of the carriage. However, other configurations may be appropriate (e.g., one or more syringe driver locks could be separately attached to the carriage). In one embodiment, the first and second syringe driver locks are each in the form of one or more gear teeth or the like so as to “mesh” with the first and second driven gears, respectively, when these components are appropriately coupled.

Consider the case where a carriage pivot and a rotational axis of the drive gear are disposed along a first reference axis, and where a first reference plane is both orthogonal to this first reference axis and extends through the pivot. In one embodiment, the drive gear is rotatably mounted on the carriage on one side of this first reference plane, while the above-noted first and second syringe driver locks are disposed on the opposite side of this first reference plane. For instance, the carriage may be an at least generally T-shaped structure, with the first and second syringe driver locks being spaced along the “horizontal” leg of this T-shaped structure, with the drive gear being rotatably interconnected with the “vertical” leg of this T-shaped structure, and with the carriage pivot interfacing with the carriage at a location along the “vertical” leg of this T-shaped structure at a location that is between the “horizontal” leg of this T-shaped structure and where the drive gear is rotatably interconnected with this T-shaped structure.

Additional characterizations may be made in relation to an injector that includes a carriage. The first drive source and at least one syringe driver lock each may be associated and move along with the carriage. A movement of the carriage thereby may responsively move the first drive source and at least one syringe driver lock. This may be accomplished by interconnecting the first drive source with the carriage in any appropriate manner, and furthermore by interconnecting at least one syringe driver lock with the carriage in any appropriate manner or by integrating at least one syringe driver lock into the structure of the carriage. In an embodiment where the injector includes a first and second syringe driver locks, the first syringe driver lock may be selectively coupled with the first syringe driver by a first movement of the carriage, while the second syringe driver lock may be selectively coupled with the second syringe driver by a second movement of the carriage.

The first drive source may be pivoted between first and second positions to be selectively coupled with the first and second syringe drivers, respectively. Moving (e.g., pivoting) the first drive source into a first position may also responsively couple a syringe driver lock (e.g., the above-noted second syringe driver lock) with the second syringe driver, while moving (e.g., pivoting) the second drive source into a second position may also responsively couple a syringe driver lock (e.g., the above-noted first syringe driver lock) with the first syringe driver. Therefore, a single common motion may couple the first drive source and the above-noted first syringe driver, and furthermore may couple a syringe driver lock with the above-noted second syringe driver. Similarly, a single common motion may couple the first drive source and the above-noted second syringe driver, and furthermore may couple a syringe driver lock with the first syringe driver.

A second aspect of the present invention is generally directed to an injector. This injector includes first and second syringe drivers, a first drive source that may be coupled with at least one of these first and second syringe drivers, a carriage, and first and second syringe driver locks. The first syringe driver lock is associated and movable along with the carriage, as is the second syringe driver lock. The first syringe driver lock is coupled with the first syringe driver and the second syringe driver lock is decoupled from the second syringe driver when the carriage undertakes a first movement. Similarly, the second syringe driver lock is coupled with the second syringe driver and the first syringe driver lock is decoupled from the first syringe driver when the carriage undertakes a second movement.

Various refinements may exist of features noted above in relation to the second aspect of the present invention. Further features may also be incorporated in the second aspect of the present invention as well. These refinements and additional features may exist individually or in any combination. The entirety of the following discussion, up to the start of the discussion of the third aspect, pertains to this second aspect unless otherwise noted. Initially, the various features discussed above that pertain to the carriage of the first aspect are equally applicable to this second aspect, whether specifically directed to the carriage or to any relationship between any other component or components and the carriage.

The first drive source may be appropriately interconnected with the carriage so as to move along with any movement of the carriage, as noted above in relation to the first aspect. In any case, the first drive source may be moved between first and second positions to selectively couple with the first and second syringe drivers, respectively. Any appropriate type of motion may be utilized for this movement of the first drive source. For instance and in one embodiment, the first drive source is pivoted between first and second positions to selectively couple with the first and second syringe drivers, respectively. In one embodiment, a movement of the first drive source to its first position to establish a coupling with the first syringe driver also causes the second syringe driver lock to become coupled with the second syringe driver, while a movement of the first drive source to its second position to establish a coupling with the second syringe driver also causes the first syringe driver lock to become coupled with the first syringe driver.

The injector may include a drive gear, a first driven gear, and a second driven gear. The drive gear may be driven by the first drive source, the first driven gear may be at least operatively coupled with the first syringe driver (including a direct coupling), the second driven gear may be at least operatively coupled with the second syringe driver (including a direct coupling), and the drive gear may be selectively coupled with each of the first and second driven gears through a certain movement of the first drive source. One movement of the first drive source may provide for a coupling between the drive gear and the first driven gear, such that a rotation of the drive gear is transmitted to the first driven gear and to thereby move at least part of the first syringe driver. Another movement of the first drive source may provide for a coupling between the drive gear and the second driven gear, such that a rotation of the drive gear is transmitted to the second driven gear and to thereby move at least part of the second syringe driver.

A third aspect of the present invention is embodied by a method for operating an injector. The method includes moving a first drive source into a first position to couple the first drive source with a first syringe driver. Thereafter, the first syringe driver may be operated (e.g., to discharge or inject fluid). The method further includes moving the first drive source into a second position to couple the first drive source with a second syringe driver. Thereafter, the second syringe driver may be operated (e.g., to discharge or inject fluid).

Various refinements may exist of features noted above in relation to the third aspect of the present invention. Further features may also be incorporated in the third aspect of the present invention as well. These refinements and additional features may exist individually or in any combination. The entirety of the following discussion pertains to this third aspect unless otherwise noted. Any type of movement may be utilized by the first drive source to selectively couple with the first and second syringe drivers. In one embodiment, the first drive source is subjected to a pivotal motion, or a motion that is at least generally about a reference axis, to selectively couple with either the first syringe driver or the second syringe driver.

The method may include locking the second syringe driver for operation of the first syringe driver, as well as locking the first syringe driver for operation of the second syringe driver. A locking of the second syringe driver may be affected in response to a movement of the first drive source to couple with the first syringe driver. Similarly, a locking of the first syringe driver may be affected in response to a movement of the first drive source to couple with the second syringe driver. That is, the same motion that causes the first drive source to become coupled with the first syringe driver may also cause a syringe driver lock to become coupled with the second syringe driver. Similarly, the same motion that causes the first drive source to become coupled with the second syringe driver may also cause a syringe driver lock to become coupled with the first syringe driver.

There are a number of features or refinements that pertain to each of the above-noted aspects, and that will now be addressed. That is, the remainder of this Summary is equally applicable to each of the first, second, and third aspects. Initially, all references to “first” or “second” herein do not specify or require an order (e.g., a “second” movement could be initiated before a “first” movement, or vice versa). The injector may be used for any appropriate application where the delivery of one or more fluids is desired, including without limitation any appropriate medical application (e.g., computed tomography or CT imaging; magnetic resonance imaging or MRI; SPECT imaging; PET imaging; X-ray imaging; angiographic imaging; optical imaging; ultrasound imaging). The injector may be used in conjunction with any component or combination of components, such as an appropriate imaging system (e.g., a CT scanner). For instance, information could be conveyed between the injector and one or more other components (e.g., scan delay information, injection start signal, injection rate). Any appropriate number of syringes may be integrated with the power injector in any appropriate manner (e.g., detachably; front-loaded; rear-loaded), any appropriate fluid may be discharged from a given syringe of the power injector, any appropriate fluid may be delivered using the first and second syringe drivers and in any appropriate manner (e.g., sequential fluid discharges from operation of the first and second syringe drivers; simultaneous fluid discharges from operation of the first and second syringe drivers), or any combination thereof.

The first drive source may be of any appropriate size, shape, configuration, and/or type, for instance an electric motor, a hydraulic motor, a pneumatic motor, or a piezoelectric motor. One or more actuators may be utilized to move the first drive source, at least one syringe driver lock, or both from one position to another (e.g., one or more actuators may interface with the above-noted carriage). Any such actuator may be of any appropriate size, shape, configuration, and/or type, and may be coupled with the relevant structure or combination of structures in any appropriate manner. For instance, a bidirectional actuator could be used to move a given structure between two positions. Another option would be to use one actuator to move a given structure from one position to another, and to use another actuator or a biasing element or a combination of biasing elements to move this same structure from one position to another. Consider the case where the above-noted drive gear (associated with the first drive source), the above-noted first driven gear (associated with the first syringe driver), and the above-noted second driven gear (associated with the second syringe driver) are each mounted on or otherwise interconnected with the above-noted carriage or pivot bracket so as to move together therewith. In this case, one or more actuators, biasing members, or the like could be used to move the carriage to realize the above-noted couplings and decouplings.

First and second syringes of any appropriate size, shape, configuration, and/or type may be operatively coupled and/or decoupled with the first and second syringe drivers, respectively, in any appropriate manner. Any such syringes may be used with or without an appropriate pressure jacket. In one embodiment, the first and second syringe drivers include first and second rams, respectively, that each move along an axial path. These first and second rams may be rotatably mounted on first and second lead or drive screws, respectively, such that to rotation of a particular drive screw will axially advance the associated ram along this drive screw.

An encoding functionality may be utilized in relation to each of the above-noted aspects, for instance to monitor the position of at least part of the first and second syringe drivers. This position monitoring functionality may be performed in any appropriate manner. Further in this regard, the operation of the first drive source may be based upon multiple inputs, for instance a desired volume to be discharged from the operation of a particular syringe driver, along with the current position of at least part of the other syringe driver. Any appropriate control logic may be utilized using at least these two inputs. In one embodiment, the differential between a target fluid delivery volume and an actual fluid delivery volume associated with the operation of one of the syringe drivers is minimized, and so as to have the first drive source in position so as to thereafter be able to couple with the other syringe driver (e.g., so that when the operation of one syringe driver is terminated after providing a fluid delivery volume that is at least “close to” the target fluid delivery volume, the first drive source may thereafter be coupled with the other syringe driver). In another embodiment, the operation of the first drive source is terminated so as to be as close as possible to the target fluid delivery volume from operation of one syringe driver and without exceeding this target fluid delivery volume, yet so the first drive source may thereafter be coupled with the other syringe driver.

### BRIEF DESCRIPTION OF THE FIGURES

FIG. 1 is one embodiment of a dual-head power injector.

FIG. 2 is a schematic of one of the rams and corresponding syringe that may be used by the dual-head power injector of FIG. 1.

FIG. 3 is a schematic of one embodiment of a drive train that may be utilized by the dual-head power injector of FIG. 1, that utilizes a single drive source, and that utilizes at least one syringe driver lock.

FIG. 4 is a perspective view of one embodiment of a drive train that may be utilized by the dual-head power injector of FIG. 1, that utilizes a single drive source, and that utilizes a pair of syringe driver locks.

FIG. 5A is an end view of a portion of the drive train of FIG. 4, in a position to lock a first side of the power injector and to simultaneously drive a second side of the power injector.

FIG. 5B is an end view of a portion of the drive train of FIG. 4, in a position to drive the first side of the power injector and to simultaneously lock the second side of the power injector.

### DETAILED DESCRIPTION

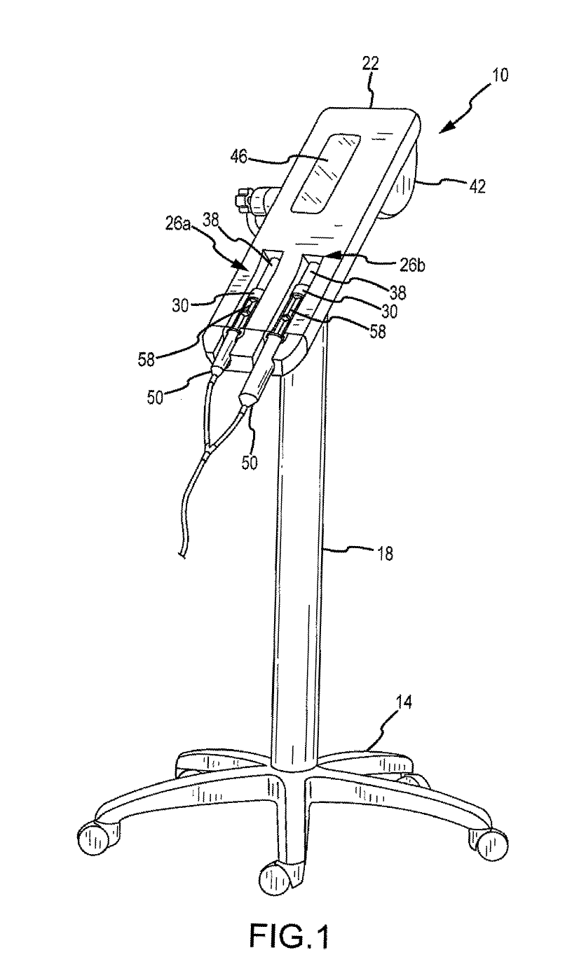

FIG. 1 is a perspective view of one embodiment of a power injector 10 that includes a movable base 14 (e.g., having a plurality of casters, rollers, or the like for portability), a column 18 that extends from the base 14, and a powerhead 22 that is typically movably interconnected with the column 18 (e.g., pivotally, for instance to accommodate being in one position to draw or otherwise load a fluid into one or more syringes 50, and being in another position for an injection procedure). The powerhead 22 may include an appropriate display or user interface screen 46 to accommodate providing one or more operational inputs to the power injector 10, to display various information, or the like. One or more other data input devices of any appropriate type could be integrated with the powerhead 22 outside of the display 46 as well.

The powerhead 22 of FIG. 1 is of a dual-head configuration, and thereby incorporates a pair of what may be characterized as syringe drivers 26a, 26b. Further in this regard, the power injector 10 thereby further includes a syringe 50 for each of the syringe drivers 26a, 26b. Typically these syringes 50 will be detachably interconnected with (e.g., mounted on) the powerhead 22 in any appropriate manner. Each syringe 50 may be of any appropriate size, shape, configuration, and/or type. Although the syringes 50 discharge into common tubing in the illustrated embodiment, such need not be the case. The injector 10 may integrate the powerhead 22 and syringes 50 in any appropriate manner, including without limitation using pressure jackets or without using pressure jackets.

Each syringe driver 26a, 26b includes a ram 30 that is threadably engaged with a corresponding drive screw 38. Rotation of a given drive screw 38 axially advances its corresponding ram 30 along its long axis in a direction that is dictated by the rotational direction of the drive screw 38. Axial movement of a given ram 30 in the direction of its corresponding syringe 50 provides for a fluid discharge from this syringe 50, while an axial movement of a given ram 30 away from its corresponding syringe 50 accommodates, for instance, loading or an introduction of an appropriate fluid into this syringe 50, a removal of the syringe 50, or both. The ram 30 may be coupled with a plunger that at least partially extends within the syringe 50, such that movement of the ram 30 away from its corresponding syringe 50 retracts its plunger. In the embodiment of FIG. 1, however, the end of the ram 30 merely “butts up” against its corresponding syringe plunger. Therefore, advancing a ram 30 toward its corresponding syringe 50 in the FIG. 1 configuration will cause the ram 30 to engage its corresponding plunger to advance the same for an injection. However, retracting the ram 30 will cause the same to disengage its corresponding plunger, such that the corresponding syringe 50 may be removed from the powerhead 22.

The drive screws 38 are rotated through an operative interconnection with a motor 42 of the power injector 10, where the motor 42 may be of any appropriate size, shape, configuration, and/or type (e.g., an electric motor, a hydraulic motor, pneumatic motor, a piezoelectric motor). Only an outer housing of the motor 42 is illustrated in FIG. 1. As will be discussed in more detail below, preferably the motor 42 is integrated with the power injector 10 in a manner so as to be movable between at least two different positions—one position establishing a coupling between the motor 42 and the drive screw 38 of the syringe driver 26a, and another position establishing a coupling between the motor 42 and the drive screw 38 of the syringe driver 26b.

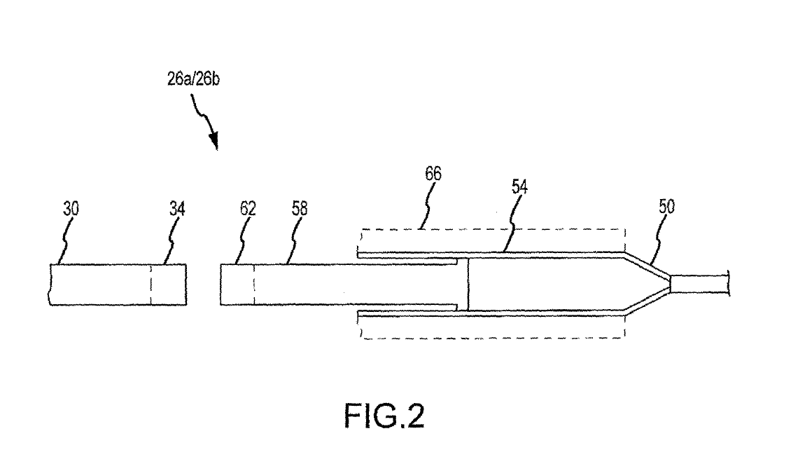

Each syringe 50 of the power injector 10 may be detachably coupled with and supported by the powerhead 22 in any appropriate manner. Each syringe 50 may also be detachably coupled with its corresponding syringe driver 26a, 26b. This detachable coupling between a syringe 50 and its corresponding syringe driver 26a, 26b may be established in any appropriate manner, and is schematically presented in FIG. 2. Here, a ram 30 is schematically illustrated as having a coupler 34 on one of its ends, although such may not be required in all instances (e.g., for the FIG. 1 configuration). The syringe 50 is also schematically illustrated as having a syringe barrel 54 (which may be disposed in a pressure jacket 66 on the powerhead 22 as desired/required), along with an axially reciprocable syringe plunger 58 that extends within the syringe barrel 54 and that may include a coupler 62 on one of its ends (although such a coupler 62 may not be required in all instances (e.g., for the FIG. 1 configuration)). The ram coupler 34, along with the syringe coupler 62, each may be of any appropriate size, shape, configuration, and/or type. A detachable coupling between a ram 30 and its corresponding syringe plunger 58 may be established in any appropriate manner, as may be a decoupling of these two components. In one embodiment, an axial advancement of the ram 30 relative to the syringe plunger 58 establishes a coupling between the ram coupler 34 and the syringe coupler 62. Decoupling of the ram 30 from its corresponding syringe plunger 58 may be accomplished by moving (e.g., rotating and/or translating) the syringe 50 relative to the corresponding ram 30 in any appropriate manner.

The power injector 10 may be used to discharge an appropriate fluid from each of the syringes 50 and in any appropriate manner (e.g., sequential discharges; simultaneous discharges). The power injector 10 may be used for any appropriate application, including without limitation for medical imaging applications. Representative medical imaging applications for the power injector 10 include without limitation computed tomography or CT imaging, magnetic resonance imaging or MRI, SPECT imaging, PET imaging, X-ray imaging, angiographic imaging, optical imaging, and ultrasound imaging. The power injector 10 could be used alone or in combination with one or more other components. The power injector 10 may be operatively interconnected with one or more components, for instances so that information may be conveyed between the power injector 10 and one or more other components (e.g., scan delay information, injection start signal, injection rate).

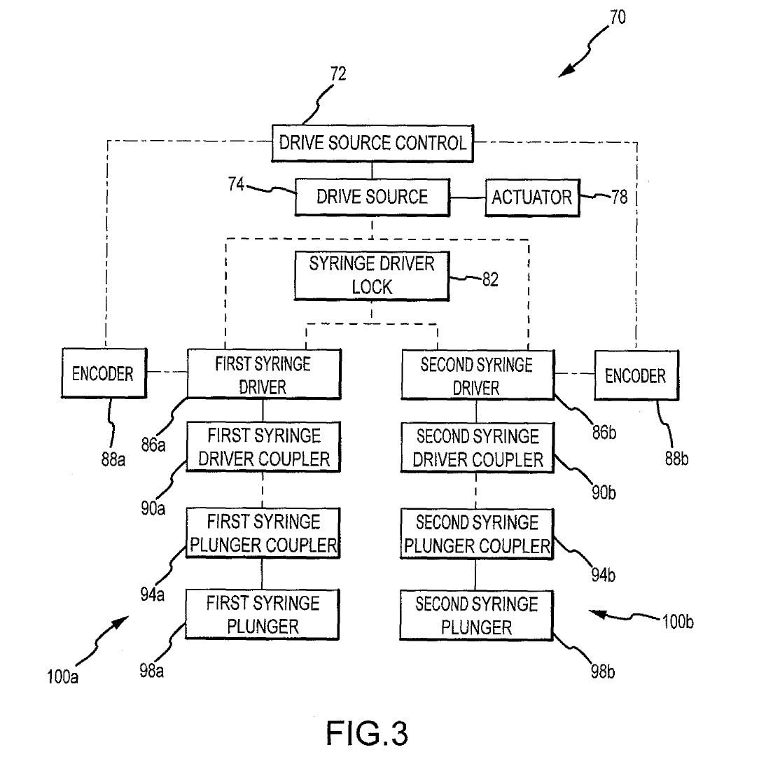

FIG. 3 illustrates one embodiment of what may be characterized as a “drive train” for any appropriate power injector (e.g., power injector 10), and which is identified by reference numeral 70. The drive train 70 is that component or combination of components that is involved with providing power to a syringe of a power injector. A solid line extending between components of the drive train 70 in FIG. 3 represents the existence of a constant coupling between such components. A dashed line extending between components of the drive train 70 in FIG. 3 represents the existence of a selective or detachable coupling between such components. Finally, a broken line extending between components of the drive train 70 in FIG. 3 represents that there is at least some type of a communications link between such components.

The drive train 70 of FIG. 3 includes a single drive source 74 that may be selectively coupled with either a first syringe driver 86a or a second syringe driver 86b, and again as indicated by the existence of a dashed line extending therebetween. This may be accomplished by moving the drive source 74 between first and second positions. One or more actuators 78 may be interconnected with the drive source 74 in any appropriate manner. Each actuator 78 may be of any appropriate size, shape, configuration, and/or type. A bidirectional actuator 78 may be utilized to move the drive source 74 to each of the first and second positions. A one-directional actuator 78 could also be utilized to move the drive source 74 to only one of the first and second positions, while the drive source 74 could be biased to the other of the first and second positions in any appropriate manner (e.g., using one or more biasing members of any appropriate size, shape, configuration, and/or type). A pair of actuators 78 could also be used to move the drive source 74 to its two positions (not shown).

At least one syringe driver lock 82 may be selectively coupled with the first syringe driver 86a and the second syringe driver 86b in the case of the drive train 70. In one embodiment and when the drive source 74 is coupled with the first syringe driver 86a, a syringe driver lock 82 may be coupled with the second syringe driver 86b, whereas when the drive source is coupled with the second syringe driver 86b, a syringe driver lock 82 may be coupled with the first syringe driver 86a. Although the same syringe driver lock 82 could interface with both the first syringe driver 86a and the second syringe driver 86b at the desired/required time, separate syringe driver locks 82 for the syringe drivers 86a, 86b could be utilized as well.

A coupling of any appropriate type between a syringe driver lock 82 and the first syringe driver 86a may fix or maintain the first syringe driver 86a in an at least substantially constant or fixed position, but in any case may preclude the first syringe driver 86a from moving in a direction that would tend to draw a fluid into the first syringe 100a. This is particularly desirable during operation of the second syringe driver 86b where fluid is being discharged from the syringe 100b. Similarly, a coupling between a syringe driver lock 82 and the second syringe driver 86b may fix or maintain the second syringe driver 86b at least substantially in a constant or fixed position, but in any case may preclude the second syringe driver 86b from moving in a direction that would tend to draw a fluid into the second syringe 100b. This is particularly desirable during operation of the first syringe driver 86a where fluid is being discharged from the syringe 100a.

The first syringe driver 86a and the second syringe driver 86b each may be of any appropriate size, shape, configuration, and/or type. In one embodiment, each of the first syringe driver 86a and the second syringe driver 86b includes a rotatable drive screw and a ram at least generally of the type discussed above with regard to FIGS. 1-2. In any case, the first syringe driver 86a may include a first syringe driver coupler 90a, whereas the first syringe 100a may include a first syringe plunger 98a and a first syringe coupler 94a. Similarly, the second syringe driver 86b may include a second syringe driver coupler 90b, whereas the second syringe 100b may include a second syringe plunger 98b and a second syringe coupler 94b. When the first syringe driver coupler 90a is coupled with the first syringe coupler 94a, power may be transmitted from the drive source 74 to the first syringe plunger 98a. Similarly, when the second syringe driver coupler 90b is coupled with the second syringe coupler 94b, power may be transmitted from the drive source 74 to the second syringe plunger 98b.

The drive train 70 of FIG. 3 may include a drive source control 72 for controlling the operation of the drive source 74 in any appropriate manner (e.g., based upon one or more inputs provided to the power injector, for instance through an appropriate console or user interface such as in the case of the display 46 used by the power injector 10 of FIG. 1). It may be desirable to utilize a first encoder 88a for the first syringe driver 86a, along with a second encoder 88b for the second syringe driver 86b. These encoders 88a, 88b may be used to monitor the associated syringe driver 86a, 86b in any appropriate manner so as to terminate the movement of the associated syringe driver 86a, 86b, respectively, in a position where: 1) the associated syringe driver 86a, 86b may be properly coupled with the associated syringe driver lock 82a, 82b; and/or 2) the other syringe driver 86a, 86b may be properly coupled with the drive source 74.

In one embodiment, an injection procedure that utilizes the drive train 70 of FIG. 3 requires: 1) a discharge of a certain volume of fluid from the first syringe 100a; 2) followed by a discharge of a certain volume of fluid from the second syringe 1006; 3) followed by a discharge of a certain volume of fluid from the first syringe 100a; and 4) followed by a discharge of a certain volume of fluid from the second syringe 100b. Generally, fluids may be sequentially discharged from the syringes 100a, 100b any number of times. The drive source control 72 may account for both the desired volume of each discharge from each of the syringes 100a, 100b, as well as information provided by the encoders 88a, 88b. With regard to the encoders 88a, 88b, again the encoders 88a, 88b may be used to terminate movement of the associated syringe driver 86a, 86b, respectively, in a position where: 1) the associated syringe driver 86a, 86b may be properly coupled with the associated syringe driver lock 82a, 82b: and/or 2) the associated syringe driver 86a, 86b may be properly coupled with the drive source 74. “Properly coupled” in accordance with the foregoing may mean so that the corresponding gear teeth of the two structures will properly mesh.

Consider the situation where a certain volume is to be discharged from the first syringe 100a (a first discharge volume), followed by a discharge of a certain volume from the second syringe 100b (a second discharge volume). The drive source control 72 for the drive source 74 may be configured to provide at least substantially the first discharge volume, while having the first syringe driver 86a in position to thereafter be coupled with a first syringe driver lock 82, to have the drive source 74 in position to thereafter couple with the second syringe driver 86b for purposes of providing at least substantially the second discharge volume, or both. Any appropriate logic could be utilized in relation to providing “at least substantially a certain discharge volume” to accommodate a switching of the drive source 74 and/or a coupling of a syringe driver lock 82 with the relevant syringe driver 86a, 86b (e.g., minimizing the difference between the target fluid discharge volume and the actual fluid discharge volume; having the actual fluid discharge volume as close to the target fluid discharge volume as possible without exceeding the target fluid discharge volume).

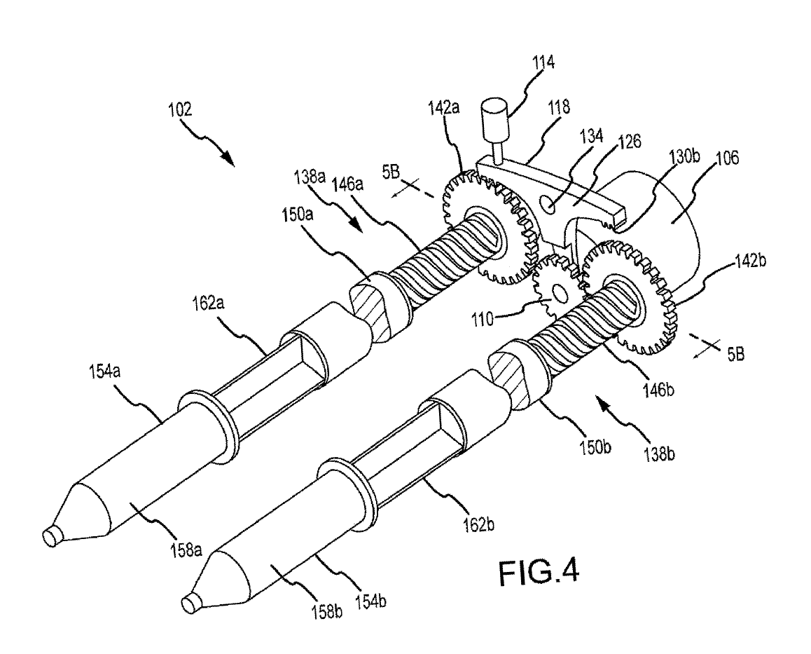

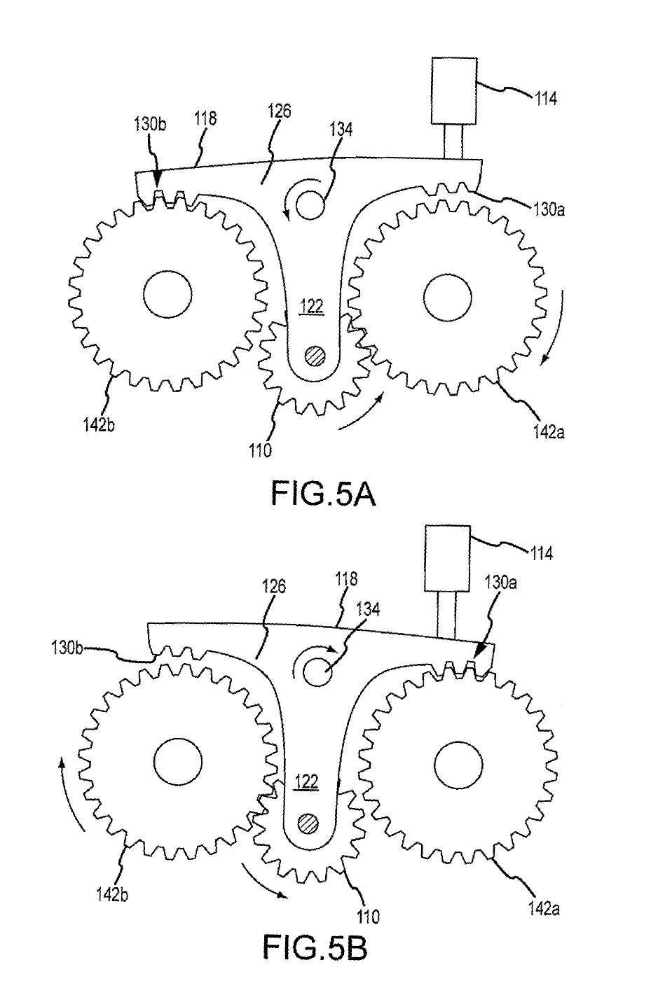

Another embodiment of a drive train is illustrated in FIG. 4 and FIGS. 5A and 5B, and furthermore is identified by reference numeral 102. The drive train 102 may be utilized by any appropriate power injector, including without limitation the power injector 10 of FIG. 1. The drive train 102 includes a motor 106 of any appropriate size, shape, configuration, and/or type (e.g., an electric motor, a hydraulic motor, a pneumatic motor, a piezoelectric motor). The motor 106 is appropriately mounted on or interconnected with what may be characterized as a carriage or pivot bracket 118. The carriage 118 is movable at least generally between first and second positions. In this regard, the carriage 118 is mounted on a pivot pin 134, such that the carriage 118 pivots at least generally between first and second positions. This pivotal motion of the carriage 118 is used to physically move the motor 106 between first and second positions to couple with first and second sides, respectively, of a power injector.

An output (e.g., a drive shaft) from the motor 106 is rotatably mounted on what may be characterized as a first leg 122 of the carriage 118. The output from the motor 106 drives a gear 110, which will hereafter be referred to as “drive gear 110.” The drive gear 110 may be of any appropriate size, and further may include any appropriate number of teeth on its perimeter, where each of these teeth may be any appropriate size, shape, and/or configuration.

The carriage or pivot bracket 118 further includes what may be characterized as a second leg 126. The first leg 122 of the carriage 118 that is associated with the motor 106 is disposed in a different orientation than the second leg 126 of the carriage 118. The second leg 126 incorporates a first syringe driver lock 130a and a separate second syringe driver lock 130b. In the illustrated embodiment, the syringe driver locks 130a, 130b each include at least one tooth and more typically a plurality of teeth. The teeth of the syringe driver locks 130a, 130b will mesh with driven gears 142a, 142b, respectively, when properly aligned therewith.

The first syringe driver lock 130a and the second syringe driver lock 130b may be selectively coupled with a first syringe driver 138a and a second syringe driver 138b. The first syringe driver 138a may be detachably coupled with a first syringe 154a, while the second syringe driver 138b may be detachably coupled with a second syringe 154b. In this regard, the first syringe 154a includes a syringe barrel 158a and an axially reciprocable syringe plunger 162a that is extendable within the syringe barrel 158a, while the second syringe 154b includes a syringe barrel 158b and an axially reciprocable syringe plunger 162b that is extendable within the syringe barrel 158b.

In the illustrated embodiment, the first syringe driver 138a includes a first driven gear 142a, a first drive screw 146a, and a first ram 150a. Similarly, the second syringe driver 138b includes a second driven gear 142b, a second drive screw 146b, and a second ram 150b. Each of the driven gears 142a, 142b may be of any appropriate size, and further may include any appropriate number of teeth on their respective perimeters, where each of these teeth may be of any appropriate size, shape, and/or configuration.

The first ram 150a of the first syringe drive 138a may be detachably coupled and decoupled with the first syringe plunger 162a in the manner discussed above in relation to FIG. 2, as may the second ram 150b of the second syringe driver 138b and the second syringe plunger 162b. The first driven gear 142a is fixed relative to the first drive screw 146a (e.g., the first driven gear 142a and the first drive screw 146a rotate together), while the first ram 150a is able to move along the first drive screw 146a during its rotation by a rotation of the first driven gear 142a. Similarly, the second driven gear 142b is fixed relative to the second drive screw 146b (e.g., the second driven gear 142b and the second drive screw 146b rotate together), while the second ram 150b is able to move along the second drive screw 146b during its rotation by a rotation of the second driven gear 142b.

The first leg 122 of the carriage 118 is located between the first driven gear 142a and the second driven gear 142b. Once again, the motor 106 is associated with this first leg 122. Movement of the carriage 118 about its pivot pin 134 selectively couples the motor 106 with one of the syringe drivers 138a, 138b and simultaneously couples the other of the syringe drivers 138a, 138b with its corresponding syringe driver lock 130a, 130b. At least one of these movements of the carriage 118 may be via one or more appropriate actuators 114. This actuator 114 may be of a bidirectional type so as to be able to move the carriage 118 into each of its two primary positions. Another option would be for the actuator 114 to move the carriage 118 to only one of its positions, while the carriage 118 would be biased to its other position in any appropriate manner (e.g., using one or more biasing members of any appropriate size, shape, configuration and/or type). Yet another option would be to use a pair of one-directional actuators—a separate actuator for moving the carriage 118 to each of its two positions (not shown).

FIGS. 5A and 5B illustrate the two primary positions of the carriage 118. When the carriage 118 is pivoted about its pivot pin 134 into the position of FIG. 5A (e.g., using the actuator 114 and/or one or more biasing members (not shown)), the drive gear 110 of the motor 106 is coupled with the first driven gear 142a associated with the first syringe 154a (e.g., one or more teeth of the drive gear 110 mesh with one or more teeth of the first driven gear 142a). At the same time, the second syringe driver lock 130b is coupled with the second driven gear 142b associated with the second syringe 154b (e.g., one or more teeth of the second syringe driver lock 130b mesh with one or more teeth of the second driven gear 142b). Therefore, there should not be any substantial movement of the second ram 150b or second syringe plunger 162b. Stated another way, both the second ram 150b and the second syringe plunger 162b should remain in an at least generally fixed position. However, rotation of the drive gear 110 by the motor 106 rotates the first driven gear 142a, which in turn rotates the first drive screw 146a. Rotation of the first drive screw 146a axially advances the first ram 150a along the first drive screw 146a, which in turn axially advances the first syringe plunger 162a in the same direction as the first ram 150a. Therefore, in the FIG. 5A configuration, fluid may be discharged from the first syringe 154a through the noted movement of the first syringe plunger 162a, while substantially no fluid should be discharged from or drawn into the second syringe 154b based upon its second syringe plunger 162b remaining in an at least substantially fixed position at this time.

When the carriage 118 is pivoted about its pivot pin 134 into the position of FIG. 5B (e.g., using the actuator 114 and/or one or more biasing members (not shown)), the drive gear 110 of the motor 106 is coupled with the second driven gear 142b associated with the second syringe 154b (e.g., one or more teeth of the drive gear 110 mesh with one or more teeth of the second driven gear 142b). At the same time, the first syringe driver lock 130a is coupled with the first driven gear 142a associated with the first syringe 154a (e.g., one or more teeth of the first syringe driver lock 130a mesh with one or more teeth of the first driven gear 142a). Therefore, there should not be any substantial movement of the first ram 150a or first syringe plunger 162a. Stated another way, both the first ram 150a and the first syringe plunger 162a should remain in an at least generally fixed position. However, rotation of the drive gear 110 by the motor 106 rotates the second driven gear 142b, which in turn rotates the second drive screw 146b. Rotation of the second drive screw 146b axially advances the second ram 150b along the second drive screw 146b, which in turn axially advances the second syringe plunger 162b in the same direction as the second ram 150b. Therefore, in the FIG. 5B configuration, fluid may be discharged from the second syringe 154b through the rioted movement of the second syringe plunger 162b, while substantially no fluid should be discharged from or drawn into the first syringe 154a based upon its first syringe plunger 162a remaining in an at least substantially fixed position at this time.

The drive train 102 of FIG. 4 may include a drive source control (not shown) for controlling the operation of the motor 106 in any appropriate manner (e.g., based upon one or more inputs provided to the power injector that utilizes the drive train 102, for instance through an appropriate console or user interface such as in the case of the display 46 used by the power injector 10 of FIG. 1). Moreover, it may be desirable to utilize a first encoder (not shown) for the first driven gear 142a, along with a second encoder (not shown) for the second driven gear 142b. These encoders may be of any appropriate type and may be used to monitor the position of the associated driven gear 142a, 142b in any appropriate manner. In any case, the encoders may be used to trigger the termination of movement of the associated driven gear 142a, 142b in a position where: 1) the associated driven gear 142a, 142b may be properly coupled with the associated syringe driver lock 130a, 130b; and/or 2) the other driven gear 142a, 142b may be properly coupled with the driven gear 110. “Properly coupled” may mean so that the corresponding gear teeth of the two structures will properly mesh.

Consider the case where a certain volume is to be discharged from the first syringe 154a (a first discharge volume), followed by a discharge of a certain volume from the second syringe 154b (a second discharge volume). The drive source control for the motor 106 may be configured to provide at least substantially the first discharge volume, while having the first driven gear 142a in position to thereafter be coupled with a first syringe driver lock 130a, to have the drive gear 110 in position to thereafter couple with the second driven gear 142b for purposes of providing at least substantially the second discharge volume, or both. Any appropriate logic could be utilized in relation to providing “at least substantially a certain discharge volume” to accommodate a switching of the drive gear 110 and/or a switching from one of the syringe driver locks 130a, 130b to the other of the syringe driver locks 130a, 130b (e.g., minimizing the difference between the target fluid discharge volume and the actual fluid discharge volume; having the actual fluid discharge volume as close to the target fluid discharge volume as possible without exceeding the target fluid discharge volume). In one embodiment, when the operation of syringe driver 86a is terminated after providing a fluid delivery volume that is at least “close to” the first discharge volume, the motor 106 may thereafter be coupled with the syringe driver 86b, the syringe drive 86a is in position to be engaged by the syringe driver lock 130a, or both. In another embodiment, the operation of the syringe driver 86a is terminated so as to be as close as possible to the first discharge volume without exceeding this first discharge volume, yet so that the motor 106 may thereafter be coupled with the syringe driver 86b, the syringe drive 86a is in position to be engaged by the syringe driver lock 130a, or both.

The foregoing description of the present invention has been presented for purposes of illustration and description. Furthermore, the description is not intended to limit the invention to the form disclosed herein. Consequently, variations and modifications commensurate with the above teachings, and skills and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

1. An injector, comprising:
a first syringe driver;
a second syringe driver;
a first drive source movable between first and second positions to selectively couple with said first and second syringe drivers, respectively; and
at least one syringe driver lock, wherein said at least one syringe driver lock locks said first syringe driver when said first drive source is coupled with said second syringe driver, and wherein said at least one syringe driver lock locks said second syringe driver when said first drive source is coupled with said first syringe driver.

2. (canceled)

3. The injector of claim 1, further comprising:
a drive gear driven by said first drive source;
a first driven gear operatively coupled with said first syringe driver; and
a second driven gear operatively coupled with said second syringe driver, wherein said drive gear may be selectively coupled with each of said first driven gear and said second driven gear through a movement of said first drive source.

4. The injector of claim 3, further comprising:
a carriage, wherein said first drive source and said drive gear are each associated and move along with said carriage.

5. The injector of claim 4, wherein at least part of said carriage is disposed between said first and second driven gears.

6. The injector of claim 4, wherein said at least one syringe driver lock comprises first and second syringe driver locks that are each associated and move along with said carriage, wherein said first syringe driver lock is coupled with said first driven gear through a first movement of said carriage, and wherein said second syringe driver lock is coupled with said second driven gear through a second movement of said carriage.

7. The injector of claim 4, further comprising:
a pivot, wherein said carriage is mounted on said pivot.

8. The injector of claim 7, wherein a pivotal motion of said carriage in a first direction about said pivot causes said drive gear to be coupled with said first driven gear and further causes said second syringe driver lock to be coupled with said second driven gear, wherein a pivotal motion of said carriage in a second direction about said pivot causes said drive gear to be coupled with said second driven gear and further causes said first syringe driver lock to be coupled with said first driven gear, and wherein said first and second directions are opposite of each other.

9. The injector of claim 7, wherein said pivot and a rotational axis of said drive gear are disposed along a first reference axis, wherein a first reference plane is orthogonal to said first reference axis and extends through said pivot, wherein said drive gear is disposed on one side of said first reference plane, and wherein said first and second syringe driver locks are disposed on an opposite side of said first reference plane.

10. The injector of claim 6, wherein said first and second syringe driver locks are integrally formed with said carriage.

11. The injector of claim 1, further comprising:
a carriage, wherein said first drive source and said at least one syringe driver lock are each associated and move along with said carriage.

12. The injector of claim 11, wherein said at least one syringe driver lock is integrally formed with said carriage.

13. The injector of claim 11, wherein said at least one syringe driver lock comprises first and second syringe driver locks, wherein said first syringe driver lock is coupled with said first syringe driver through a first movement of said carriage, and wherein said second syringe driver lock is coupled with said second syringe driver through a second movement of said carriage.

14. The injector of claim 1, wherein pivoting said first drive source into said first position responsively couples said at least one syringe driver lock with said second syringe driver, and wherein pivoting said first drive source into said second position responsively couples said at least one syringe driver lock with said first syringe driver.

15. The injector of claim 1, wherein moving said first drive source into said first position responsively couples said at least one syringe driver lock with said second syringe driver, and wherein moving said first drive source into said second position responsively couples said at least one syringe driver lock with said first syringe driver.

16. The injector of claim 1, wherein said at least one syringe driver lock comprises first and second syringe driver locks.

17. The injector of claim 16, wherein said first syringe driver lock is simultaneously coupled with said first syringe driver when said first drive source is coupled with said second syringe driver, and wherein said second syringe driver lock is simultaneously coupled with said second syringe driver when said first drive source is coupled with said first syringe driver.

18. The injector of claim 16, wherein said first and second driver locks are part of a common structure.

19. The injector of claim 16, wherein said first and second syringe driver locks responsively move with a movement of said first drive source between said first and second positions.

20-31. (canceled)

32. The injector of claim 1, wherein said first drive source is pivotable between multiple positions to selectively couple with said first and second syringe drivers, respectively.

33. The injector of claim 1, wherein said first drive source is selected from the group consisting of electric motor, a hydraulic motor, a pneumatic motor, and a piezoelectric motor.

34. The injector of claim 1, further comprising first and second syringes operatively interconnected with said first and second syringe drivers, respectively.

35. The injector of claim 1, wherein said first and second syringe drivers comprise first and second rams, respectively, that are each movable along an axial path.

36. The injector of claim 35, wherein said first and second syringe drivers further comprise first and second drive screws, wherein said first and second rams are mounted on said first and second drive screws, respectively, and move along said first and second drive screws, respectively, by rotation of said first and second drive screws, respectively.

37. The injector of claim 1, further comprising:
at least one actuator, wherein said at least one actuator is operable to move said first drive source from one position to another position.

38. The injector of claim 1, further comprising:
at least one actuator, wherein said at least one actuator is operable to move said first drive source to at least two different positions.

39. The injector of claim 1, further comprising a control logic, a first encoder, and a second encoder, wherein said first and second encoders are operatively interconnected with said control logic, and wherein said first and second encoders provide position information on said first and second syringe drivers, respectively.

40-53. (canceled)
